(19) United States
(12) Patent Application Publication
(10) Pub. No.: US 2012/0106197 A1
(43) Pub. Date: May 3, 2012

(54) Flat Panel Display Structure and Manufacturing Method Thereof

(75) Inventors: Ching-Kun Lai, Hsin-Chu (TW); Ching-Chuan Chen, Hsin-Chu (TW); Hong-Jye Hong, Hsin-Chu (TW)

(73) Assignee: AU OPTRONICS CORPORATION, Hsin-Chu (TW)

(21) Appl. No.: 13/249,463

(22) Filed: Sep. 30, 2011

(30) Foreign Application Priority Data
Oct. 29, 2010 (TW) 099137224

(51) Int. Cl. F21V 7/00; B32B 37/14; B32B 38/04; F21V 8/00; B32B 37/12

(52) U.S. Cl. 362/609; 362/613; 156/305; 156/252

(57) ABSTRACT

A flat panel display structure and a manufacturing method thereof are provided. The flat panel display structure includes a light guide plate made of optical glass, an optical film disposed on the light guide plate and glued thereon through a first glue layer, a display panel having a light incident surface facing the optical film and a display surface with an active area located at the central portion thereof, a second glue layer gluing the optical film and the display panel so as to cover the light incident surface including the projection of the display area thereon, and a light module emitting lights toward the light guide plate. The refractive indices of the first glue layer and the second glue layer are smaller than or equal to that of the light guide plate and the optical film.

### BACKGROUND OF THE INVENTION

1. Field of the Invention

The present invention relates to a flat panel display structure and a manufacturing method thereof. Particularly, the present invention relates a to a flat panel display structure of a display panel, an optical film, and a light guide plate attached to one another.

2. Description of the Prior Art

Besides the display panel, the most important unit in the liquid crystal display is the backlight module. The backlight module is used for providing an outer light source to achieve the display function because the liquid crystal molecular itself can not emit light. The backlight module disposed behind the liquid crystal display panel is mainly composed of a light guide plate and a light emitting component. Light emitted from the light emitting component is transmitted through the light guide plate and projects uniformly to the liquid crystal display panel to form the display light source.

In addition, in order to enhance the light efficiency and provide uniform light source, different optical films such as brightness enhancement films (BEF) or diffuser films may be disposed in the backlight module. The optical films are usually disposed between the light guide plate and the display panel and are fixed therebetween.

The liquid crystal display product nowadays is devoted to large-scale and thin thickness. However, the optical films simply placed in the backlight module are susceptible to deformation and such deformation will be more obvious in large-scale products. Also, as the liquid crystal display keeps getting thinner and thinner, its structural strength becomes weaker and weaker.

### SUMMARY OF THE INVENTION

One object of the present invention is to provide a flat panel display structure. Comparing to the prior art, the flat panel display structure of the present invention can prevent deformation of components such as optical films and display panel and can enhance the strength of the whole structure.

Another object of the present invention is to provide a manufacturing method of the above-mentioned flat panel display structure. Comparing to the prior art, the manufacturing method of the present invention can prevent deformation of components such as optical films and display panel and can also simplify the process of assembling components.

The flat panel display structure of the present invention includes a light guide plate, an optical film, a first glue layer, a display panel, a second glue layer, and a light module emitting light toward the light guide plate. The light guide plate is made of optical glass. The optical film is disposed on the light guide plate and attached thereto by the first glue layer. The display panel includes a light incident surface and a display surface, wherein the light incident surface faces the optical film and the central portion of the display surface has an active area. The second glue layer attaches the optical film to the display panel and covers the light incident surface including the projection of the active area thereon. The reflective indices of the first glue layer and the second glue layer are both less than or equal to the reflective indices of light guide plate and the optical film. The flat panel display structure of the present invention utilizes the structure of the display panel, the optical film, and the light guide plate attached to one another to prevent deformation of components such as optical film and display panel and enhances the strength of the whole structure.

The manufacturing method of the flat display structure of the present invention includes the following steps: disposing and attaching a first glue layer between optical film and a light guide plate made of an optical glass; disposing and attaching a second glue layer between the optical film and a display panel to allow a light incident surface of the display panel to face the optical film, the second glue layer covering the light incident surface including the projection of an active area; disposing a light module emitting light toward the light guide plate. The reflective indices of the first glue layer and the second glue layer are both smaller than or equal to the reflective indices of the light guide plate and the optical film, and the active area is located on a central portion of the display surface opposite to the light incident surface. The manufacturing method of the present invention, on the one hand, prevents deformation of components such as optical film and display panel by attaching the display panel, the optical film, and the light guide plate to one another; on the other hand, it simplifies the process of assembling components.

### BRIEF DESCRIPTION OF THE DRAWINGS

FIG. 1 is a cross-sectional view of the first embodiment of the flat panel display structure;

FIG. 2 is a schematic view of the light module of the flat panel display structure as shown in FIG. 1;

FIG. 3 is a schematic view of the second embodiment of the flat panel display structure;

FIG. 4 is a schematic view of the third embodiment of the flat panel display structure;

FIG. 5 is a schematic view of the fourth embodiment of the flat panel display structure;

FIG. 6A is a schematic view of the fifth embodiment of the flat panel display structure;

FIG. 6B is a schematic view of the reflective cover of the flat panel display structure as shown in FIG. 6A;

FIG. 7A is a schematic view of an embodiment of the buffer pad of the flat panel display structure;

FIG. 7B is a schematic view of disposing the buffer pad of the flat panel display structure;

FIG. 8A is a schematic view of disposing the black light-shielding tape on the flat panel display structure as shown in FIG. 1;

FIG. 8B is a top view of disposing the black light-shielding tape on the flat panel display structure as shown in FIG. 8A;

FIG. 9A is a schematic view of disposing the black light-shielding tape on the flat panel display structure as shown in FIG. 4;

FIG. 9B is a schematic view of different embodiment of disposing the black light-shielding tape on the flat panel display structure;

FIG. 9C is a schematic view of different embodiment of disposing the black light-shielding tape on the flat panel display structure;

FIG. 10 is a schematic view of the processing steps of the first embodiment of the manufacturing method of the flat panel display structure;

FIG. 11 is a schematic view of the processing steps of the second embodiment of the manufacturing method of the flat panel display structure;

FIG. 12 is a schematic view of the processing steps of the third embodiment of the manufacturing method of the flat panel display structure;

FIG. 13 is a schematic view of the processing steps of the fourth embodiment of the manufacturing method of the flat panel display structure;

FIG. 14 is a schematic view of the processing steps of the fifth embodiment of the manufacturing method of the flat panel display structure;

FIG. 15 is a schematic view of the processing steps of the sixth embodiment of the manufacturing method of the flat panel display structure;

FIG. 16 is a schematic view of the processing steps of the seventh embodiment of the manufacturing method of the flat panel display structure.

### DETAILED DESCRIPTION OF THE PREFERRED EMBODIMENT

The present invention provides a flat panel display structure and a manufacturing method thereof. In the preferred embodiment, the flat panel display structure and the manufacturing method thereof may be utilized in liquid crystal displays and the manufacturing process thereof. However, in other embodiments, the flat panel display structure and the manufacturing method thereof may be utilized in other types of displays and the manufacturing process thereof.

FIG. 1 is a cross-sectional view of the first embodiment of the flat panel display structure. As shown in FIG. 1, the flat panel display structure includes a light guide plate 10, an optical film 20, a first glue layer 30, a display panel 40, a second glue layer 50, a light module 60, a reflector 70, and a back plate 80. The light guide plate 10 is an optical glass and the material can be soda glass, silica glass, ultra clear glass, or other types of optical glass. The light guide plate 10 includes a light incident side 11, a light emitting surface 12, and a bottom surface 13, the light emitting surface 12 and the bottom surface 13 are two opposite surfaces connected to an edge of the light incident side 11, respectively. The light emitting surface 12 faces the optical film 20. The optical film 20 is disposed on the light guide plate 10 and attached onto the light guide plate 10 by the first glue layer 30. In a preferred embodiment, the optical film 20 is a multilayer composite film; however, in other embodiments, the optical film 20 may be multiple optical films attached together. The display panel 40 includes a light incident surface 41 and a display surface 42 opposite to the light incident surface 41, wherein the light incident surface 41 faces the optical film 20, and an active area 421 is located on a central portion of the display surface 42. The second glue layer 50 attaches the optical film 20 to the display panel 40, wherein the second glue layer 50 covers the light incident surface 41 including the projection of the active area 421 thereon. The first glue layer 30 and the second glue layer 50 may be disposed by attaching or by coating, and the refractive indices of the first glue layer 30 and the second glue layer 50 are both equal to or smaller than the refractive index of the light guide plate 10 and the refractive index of the optical film 20. In a preferred embodiment, the first glue layer 30 and the second glue layer 50 are optical glues having a refractive index substantially between 1.2 and 1.4. However, in other embodiments, the first glue layer 30 and the second glue layer 50 can be other adhesive materials with a refractive index close to the refractive index of air. Because the thermal expansion coefficient of the light guide plate 10 made of optical glass is close to the thermal expansion coefficient of the display panel 40, the connection/attachment of the display panel 40, the optical film 20, and the light guide plate 10 is not easy to be influenced by thermal expansion.

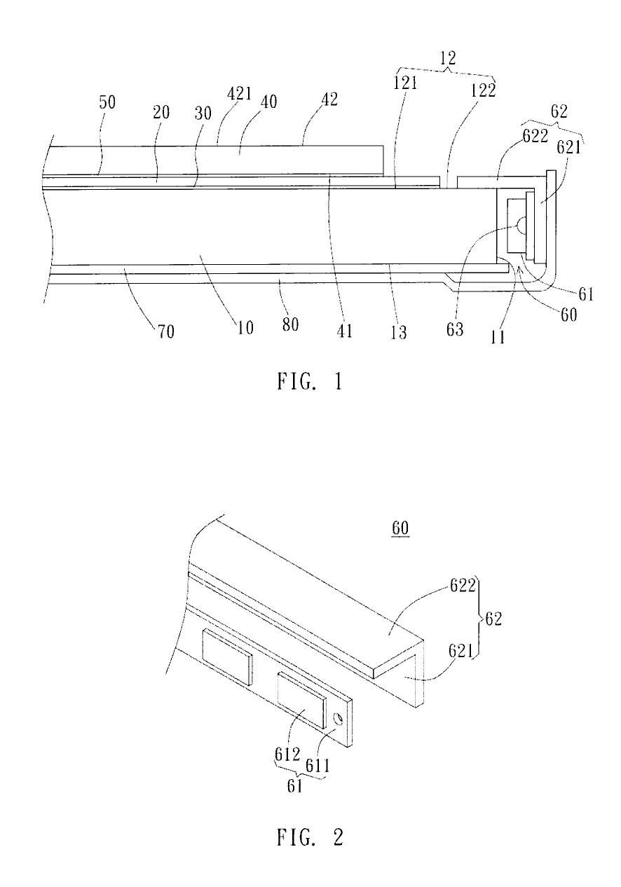

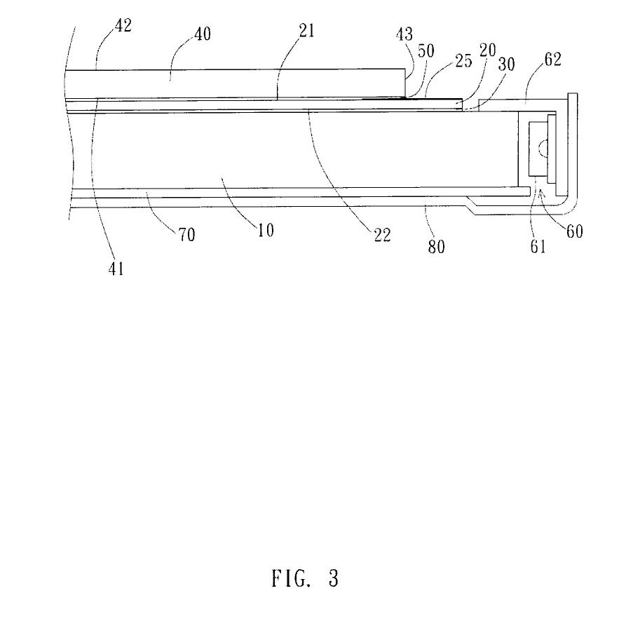

FIG. 2 is a schematic view of the light module of the flat panel display structure as shown in FIG. 1. As shown in FIG. 1 and FIG. 2, the light module 60 is disposed along the light incident side 11 of the light guide plate 10 and emits light toward the light incident side 11. The light module 60 includes a light emitting unit 61 and a reflective cover 62. In this embodiment, the light emitting unit 61 is a light bar including a plurality of light emitting diodes; however, in other embodiments, the light emitting unit 61 may include other types of light emitting components such as cold cathode fluorescent lamp (CCFL). In this embodiment, the light emitting unit 61 is fastened to the reflective cover 62 by a screw 63; however, in other embodiments, the light emitting unit 61 may be fixed on the reflective cover 62 by other methods such as using double-sided tapes. The light emitting unit 61 is preferably a light bar and emits light toward the light incident side 11. The reflective cover 62 includes a first reflective portion 621 and a second reflective portion 622 connected to each other and reflects light from the light emitting unit 61 toward the light guide plate 10. The first reflective portion 621 is disposed along the light incident side 11, and the second reflective portion 622 extends from a plane where the first reflective portion 621 is located toward the light guide plate 10 and crosses the boundary of the light incident side 11 and the light emitting surface 12. The light emitting surface 12 includes a light emitting portion 121 and an edge portion 122 adjacent to each other, wherein the optical film 20 is disposed on the light emitting portion 121, and the second reflective portion 622 of the light module 60 is attached to the surface of the edge portion 122. In a preferred embodiment, the double-sided tape is used to attach the light module 60 to the light guide plate 10; however, in other embodiments, other types of adhesive materials may be adopted for attachment. Moreover, in this embodiment, the first reflective portion 621 and the second reflective portion 622 are perpendicular to each other to allow the cross-sectional view of the reflective cover 62 to form an L shape; however, in other embodiments, the first reflective portion 621 and the second reflective portion 622 may connect at an angle other than right angle.

As shown in FIG. 1, in this embodiment, the reflector 70 is disposed corresponding to the bottom surface 13 of the light guide plate 10 and reflects light from the bottom surface 13 of the light guide plate 10 for light recycle; however, in other embodiments, the reflector 70 is optional and can be omitted. The reflector 70 is preferably attached to the bottom surface 13 by adhesives such as optical glue. The back plate 80 is used for supporting components such as the light guide plate 10, the optical film 20, the display panel 40, the light module 60, and the reflector 70. In a preferred embodiment, adhesive materials such as double-sided tape can be used to attach the reflector 70 to the back plate 80. However, in other embodiments, the back plate 80 is optional and can be omitted. Besides, the back plate 80 may adopt different designs such as adopting other materials or structures to form the back plate 80.

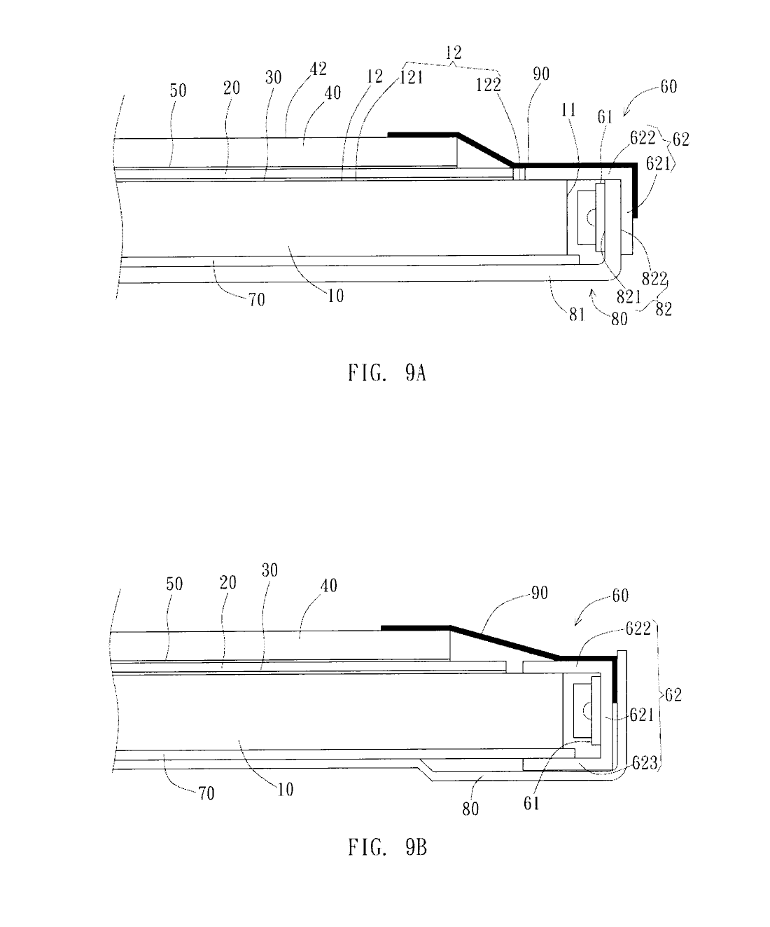

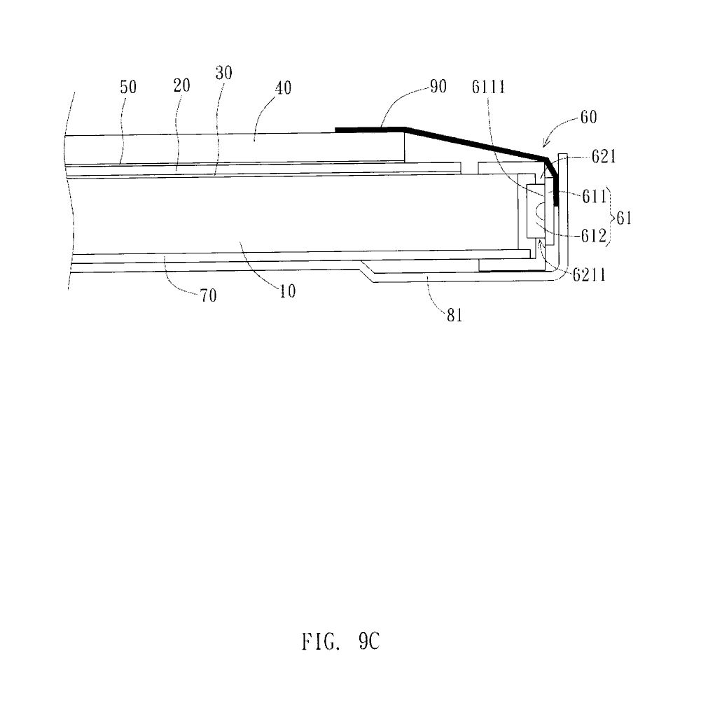

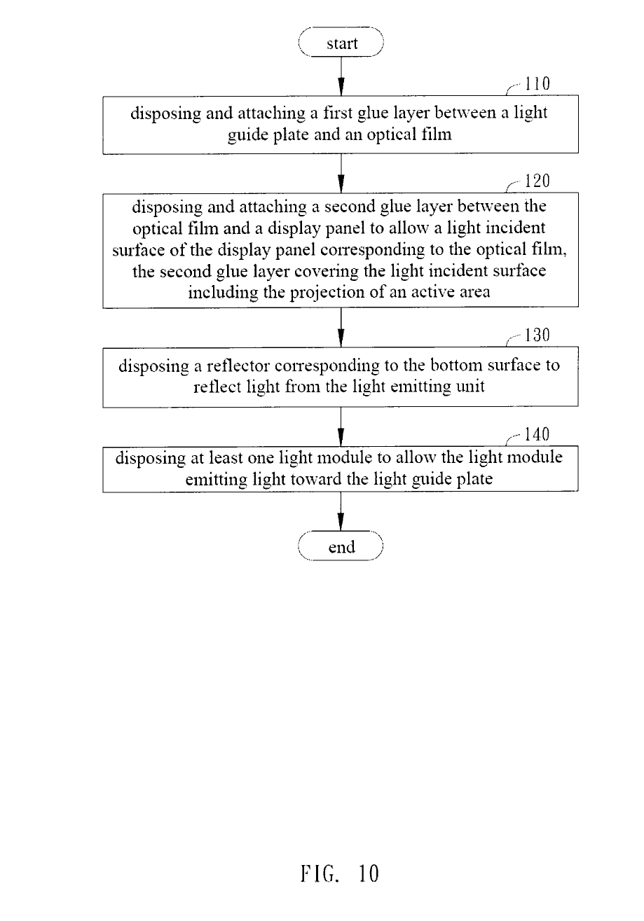

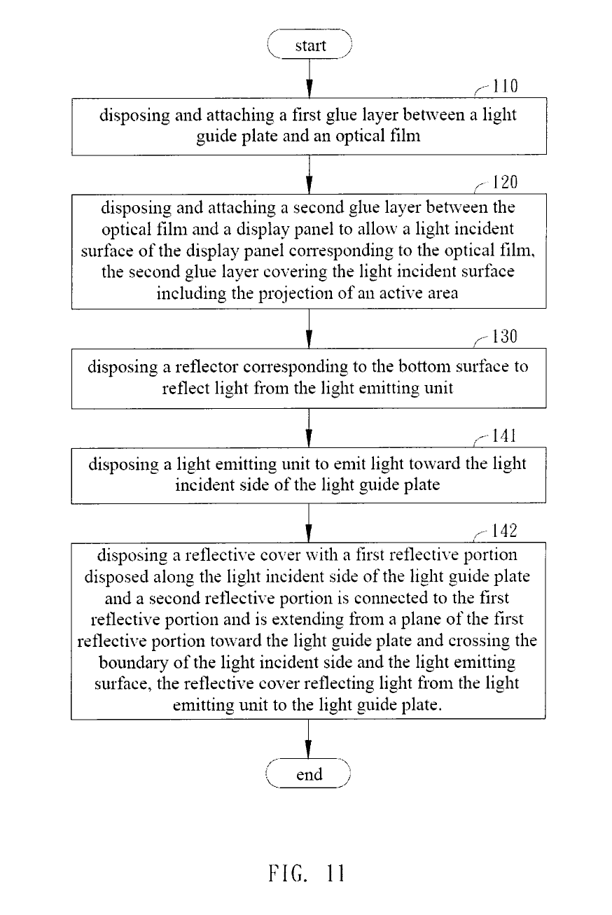

FIG. 3 is a schematic view of the second embodiment of the flat panel display structure. As shown in FIG. 3, in this embodiment, the optical film 20 includes an upper surface 21 and a lower surface 22 opposite to the upper surface 21, wherein a light shielding layer 25 is formed on the periphery of the upper surface 21 facing the display 40 to prevent glare from occurring at the periphery of the display panel 40 to affect the visual effect. The light shielding layer 25 extends inward to cross the projection of the display panel 40 on the optical film 20. That is, the light shielding layer 25 extends to cross the boundary of the side edge 43 of the display panel 40 and the light incident surface 41. The light shielding layer 25 is preferably made by ink printing and the second glue layer 50 covers at least a portion of the light shielding layer 25. In this embodiment, the second glue layer 50 covers a portion of the light shielding layer 25 that faces the light incident surface 41. In other embodiments, the light shielding layer 25 can be disposed on the periphery of the lower surface 22 facing the light guide plate 10 or disposed on the periphery of both of the lower surface 22 and the upper surface 21, or other components capable of preventing glare can be disposed. (please refer to the embodiments shown in the FIG. 8A, FIG. 9A, FIG. 9B, and FIG. 9C)

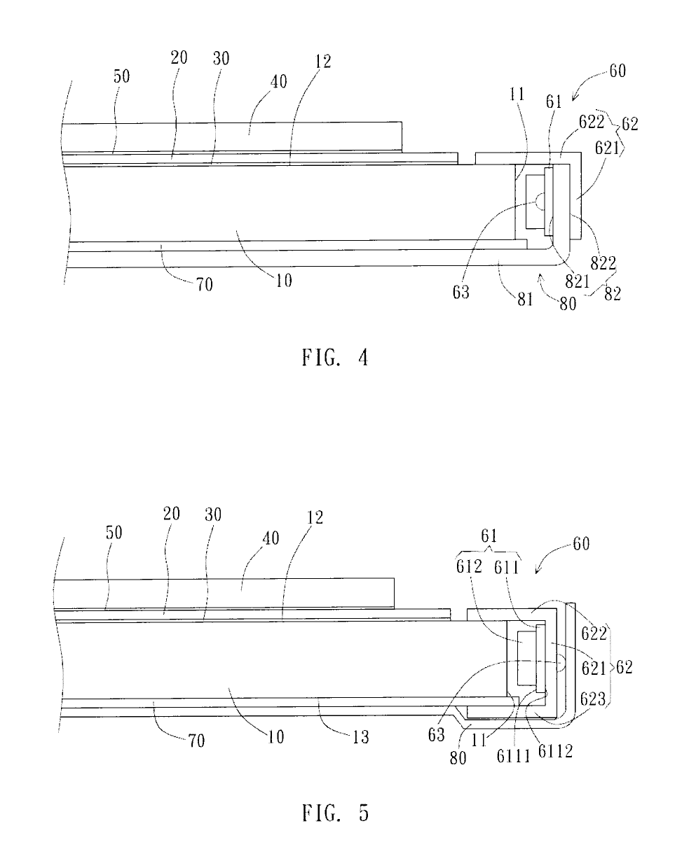

FIG. 4 is a schematic view of the third embodiment of the flat panel display structure. As shown in FIG. 4, the back plate 80 includes a bottom plate 81 and a sidewall 82 connected at an angle. The light guide plate 10 is disposed on the bottom plate 81 and the sidewall 82 has an inner surface 821 and an outer surface 822. The light emitting unit 61 is disposed on the inner surface 821 that faces the light guide plate 10 and the first reflective portion 621 of the reflective cover 62 is attached to the outer surface 822. In this embodiment, the double-sided tape is used to attach the light module 60 to the light guide plate 10 as well as the light module 60 to the back plate 80; however, in other embodiments, the connection or attachment may be achieved by other types of adhesive materials.

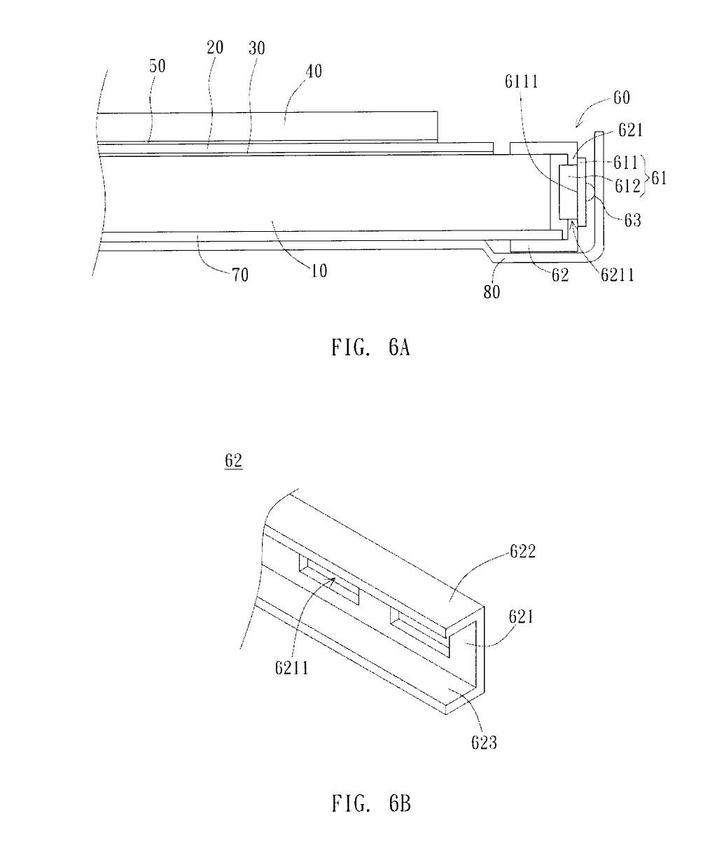

FIG. 5 is a schematic view of the fourth embodiment of the flat panel display structure. As shown in FIG. 5, the reflective cover 62 includes a first reflective portion 621, a second reflective portion 622, and a third reflective portion 623 connected to each other. The first reflective portion 621 is disposed along the light incident side 11. The second reflective portion 622 and the third reflective portion 623 respectively connect two ends of the first reflective portion 621 to extend from a plane where the first reflective portion 621 is located toward the light guide plate 10 and cross the boundary of the light incident side 11 and the bottom surface 13. In this embodiment, the second reflective portion 622 is attached onto the light emitting surface 12 and the third reflective portion 623 is attached onto the reflector 70; however, in other embodiments, the third reflective portion 623 may be attached onto the bottom surface 13. In a preferred embodiment, the double-sided tape is used to attach the light module 60 to the light guide plate 10 and attach the light module 60 to the reflector 70; however, in other embodiments, the connection or attachment may be achieved by other types of adhesive materials.

In this embodiment, the light emitting unit 61 includes a substrate 611 and multiple light emitting components 612. The light emitting unit 61 is preferably a light bar, and the light emitting components 612 are preferably light emitting diodes. The substrate 611 includes a first surface 6111 and a second surface 6112. The first surface 6111 faces the light incident side 11 of the light guide plate 10, and the light emitting components 612 are disposed on the first surface 6111 and emit light toward the light incident side 11. The second surface 6112 is attached to the inner surface of the first reflective portion 621 of the reflective cover 62. However, in other embodiments, the light emitting unit 61 may be disposed on the reflective cover 62 by other methods. FIG. 6A is a schematic view of the fifth embodiment of the flat panel display structure and FIG. 6B is a schematic view of the reflective cover of the flat panel display structure as shown in FIG. 6A. As shown in FIG. 6A and FIG. 6B, a through hole 6211 is formed on the first reflective portion 621 of the reflective cover 62 to allow the light emitting component 612 to pass therethrough, and a portion of the first surface 6111 of the substrate 611 is attached to the outer surface of the first reflective portion 621.

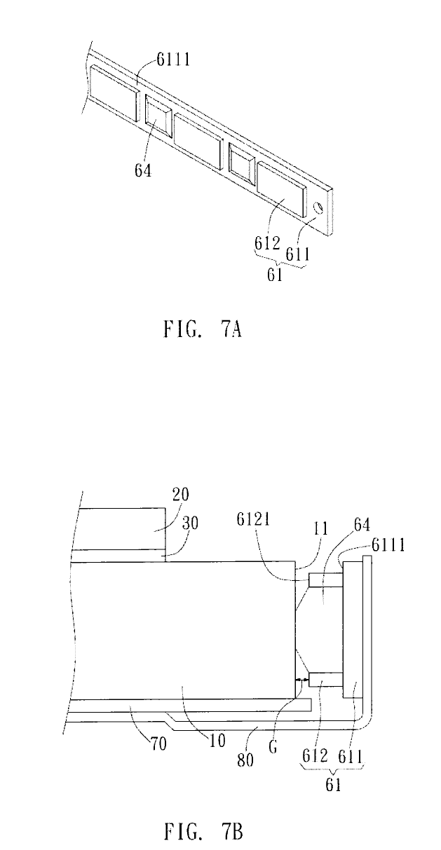

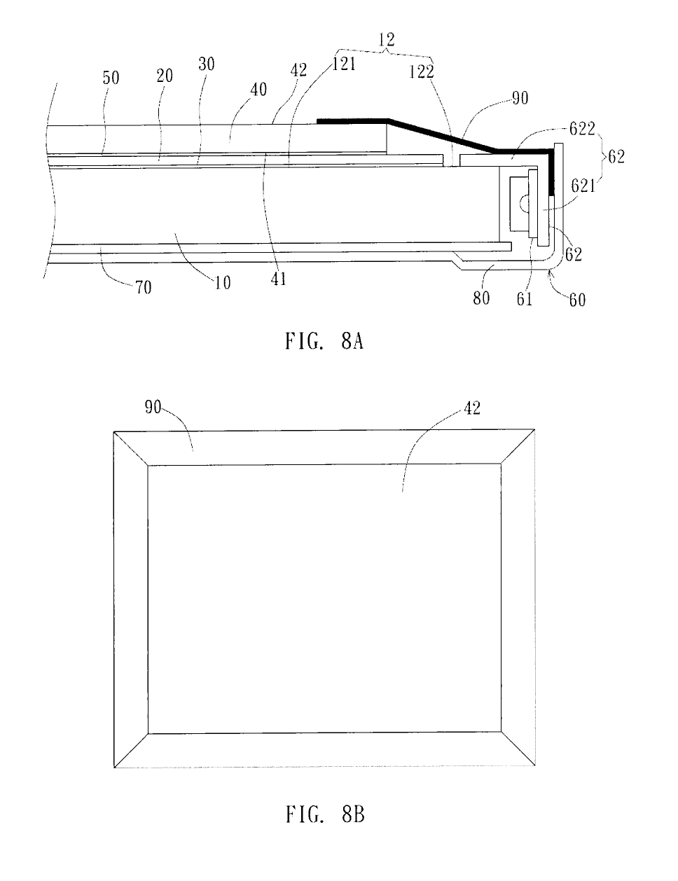

The light emitting unit 61 is disposed along the light incident side 11 of the light guide plate 10 to allow the first reflective portion 621 to approach to the light incident side 11. Meanwhile, a buffer pad 64 may be disposed between the light emitting unit 61 and the light guide plate 10 for the convenient positioning as assembling the light emitting unit 61 and to prevent the light emitting component 612 from directly contacting to the light guide plate 10 and causing damage. FIG. 7A is a schematic view of an embodiment of the buffer pad of the flat panel display structure and FIG. 7B is a schematic view of disposing the buffer pad of the flat panel display structure. As shown in FIG. 7A and FIG. 7B, the buffer pad 64 is disposed on the first surface 6111 of the substrate 611. The light emitting component 612 has a top surface 6121 facing the light incident side 11 of the light guide plate 10 and the buffer pad 64 touches the light incident side 11 to maintain a gap G between the top surface 6121 and the light incident side 11. The gap G helps the light emitting component 612 for heat dissipation and keeps optical effect to prevent problems such as hot spots occurred. The size of the gap G is preferably between 0.5 mm and 1 mm. The material of the buffer pad 64 can be rubber, silicone rubber, or other elastic materials.

FIG. 8A is a schematic view of disposing a black light-shielding tape on the flat panel display structure as shown in FIG. 1 and FIG. 8B is a top view of disposing the black light-shielding tape on the flat panel display structure as shown in FIG. 8A. As shown in FIG. 8A and FIG. 8B, a black light-shielding tape 90 is disposed along the periphery of the display surface 42 of the display panel 40, and crosses the optical film 20 to be attached to the first reflective portion 621 of the reflective cover 62 to prevent light emitted from the light emitting unit 61 from leaking from the periphery of the display panel 40, the optical film 20, and the light guide plate 10. In a preferred embodiment, the black light-shielding tape 90 is Mylar tape; however, in other embodiments, the black light-shielding tape 90 may be other types of light-shielding tapes. In this embodiment having the black light-shielding tape 90, the reflector 70 is preferably attached to the bottom surface 11 of the light guide plate 10 to reflect light from the light emitting unit 61 toward the light guide plate 10. Meanwhile, the flat panel display structure can be further assembled with an outer frame to form a complete flat display product.

FIG. 9A is a schematic view of disposing a black light-shielding tape on the flat panel display structure as shown in FIG. 4. As shown in FIG. 9A, the black light-shielding tape 90 is attached along the periphery of the display surface 42 of the display panel 40 and crosses the optical film 20 to be attached to the first reflective portion 621 and a second reflective portion 622 of the reflective cover 62. FIG. 9B is a schematic view of different embodiment of disposing a black light-shielding tape on the flat panel display structure. As shown in FIG. 9B, the black light-shielding tape 90 is attached along the periphery of the display surface 42 of the display panel 40 and crosses the optical film 20 to be attached to the first reflective portion 621 and a second reflective portion 622 of the reflective cover 62. FIG. 9C is a schematic view of different embodiment of disposing a black light-shielding tape on the flat panel display structure. As shown in FIG. 9C, the black light-shielding tape 90 is attached along the periphery of the display surface 42 of the display panel 40 and crosses the optical film 20 to be attached to the substrate 611 of the light emitting unit 61. Furthermore, the flat panel display structure shown in FIG. 9A, FIG. 9B, or FIG. 9C can be assembled with an outer frame to form a complete flat display product.

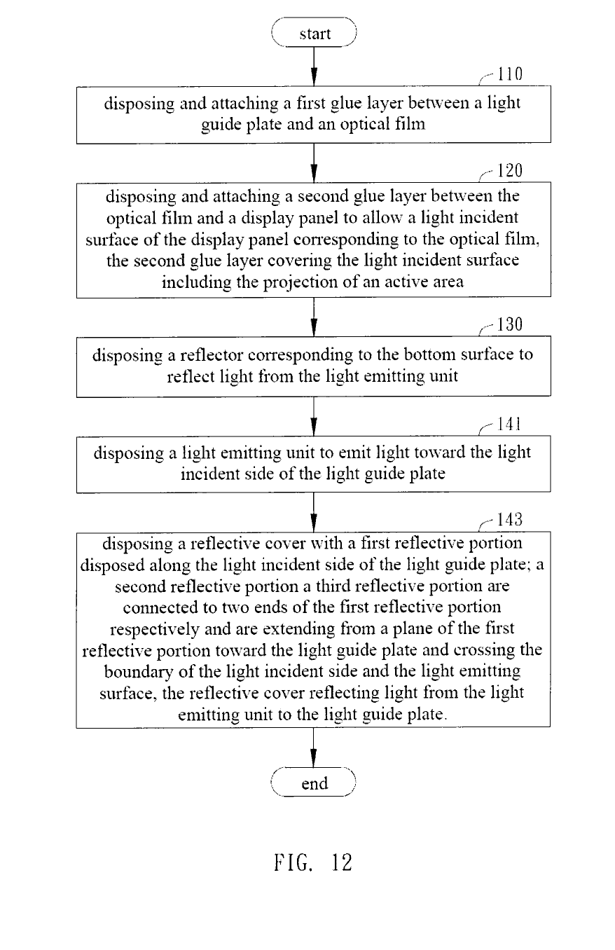

FIG. 10 is a schematic view of the processing steps of the first embodiment of the manufacturing method of the flat panel display structure. The related components in this embodiment include a light guide plate, an optical film, a first glue layer, a display panel, a second glue layer, a light module emitting light toward the light guide plate, and a reflector (please refer to the embodiment shown in FIG. 1). As shown in FIG. 10, the step 110 includes disposing and attaching the first glue layer between the light guide plate made of optical glass material and the optical film. The light guide plate is an optical glass plate including material of soda glass, silica glass, ultra clear glass or other types of optical glass. The first glue layer may de disposed by coating or attaching and the refractive index of the first glue layer is small than or equal to the refractive index of the light guide plate and the refractive index of the optical film. In a preferred embodiment, the first glue layer is optical glue having a refractive index between 1.2 and 1.4; however, in other embodiments, other types of glues may be adopted and their refractive index may be close to the refractive index of air.

In other embodiments, the step 110 may include forming a light shielding layer on a periphery of a surface of the optical film facing the display panel or on a periphery of another surface of the optical film opposite to the display panel, wherein the light shielding layer extends inward to cross the projection of the display panel on the optical film (please refer to the FIG. 3). The light shielding layer is preferably made by ink printing and the second glue layer covers at least a portion of the light shielding layer. In other embodiments, the light shielding layer may be disposed on the periphery of the surface of the light guide plate or both on the surface and the periphery of the light guide plate, or other anti-glare components can be disposed (please refer to FIG. 8A, FIG. 9A, FIG. 9B, and FIG. 9C).

Step 120 includes disposing and attaching the second glue layer between the optical film and the display panel to allow the light incident surface of the display panel faces the optical film, wherein the second glue layer covers the light incident surface including the projection of an active area. The second glue layer may be disposed by coating of by attaching and the reflective index of the second glue layer is smaller than or equal to the reflective indices of the light guide plate and the optical film. In a preferred embodiment, the second glue layer is optical glue having a reflective index between 1.2 and 1.4; however, in other embodiments, other glues with reflective index close to the reflective index of air may be adopted. Besides, in a preferred embodiment, the optical film is a multilayer composite film; however, in other embodiments, the optical film 20 may be a plurality of optical films attached together. The active area of the display panel is located on the central portion of the display surface. In other embodiments, when the light shielding layer is disposed on the surface of the optical film, the step 120 further includes enabling the second glue layer to cover at least a portion of the light shielding layer (please refer to the FIG. 3).

Step 130 includes disposing the reflector corresponding to the bottom surface to reflect light from the light emitting unit. The reflector is preferably attached to the bottom surface by adhesives such as optical glue. In other embodiments, the reflector may not require. Step 140 includes disposing the light module to allow the light module to emit light toward the light guide plate. In this embodiment, the light module includes a light bar consisting of a plurality of light emitting diodes; however, in other embodiments, other light emitting components such as cold cathode lamp may be adopted as the light module. The manufacturing method of the flat panel display structure of the present invention attaches the display panel, the optical film, and the light guide plate to each other to prevent deformation of components such as the optical film, the display panel and also simplifies the assembling procedure of components.

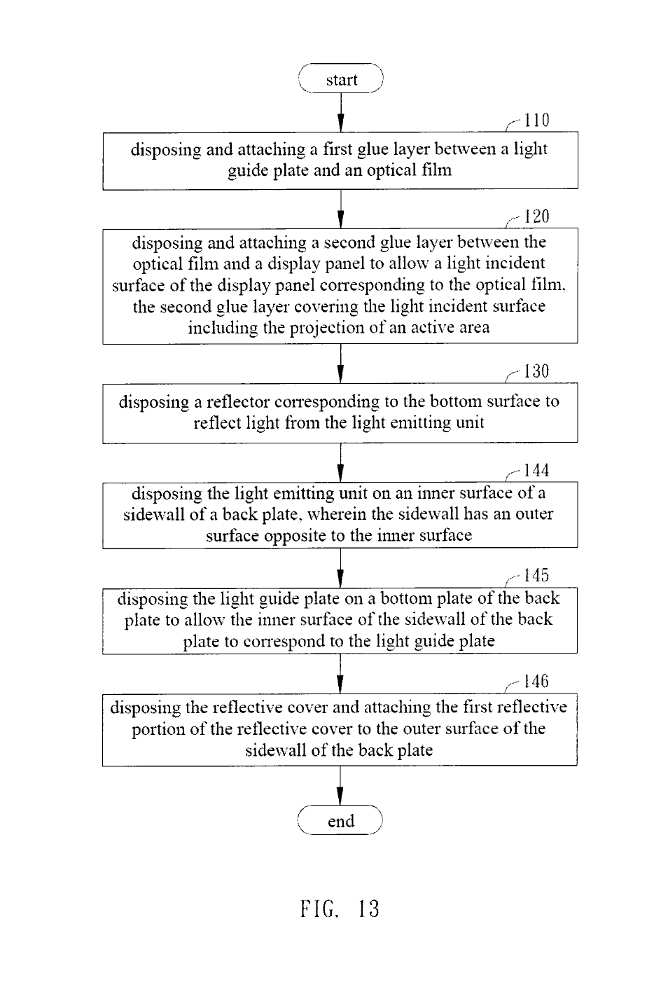

FIG. 11 is a schematic view of the processing steps of the second embodiment of the manufacturing method of the flat panel display structure. The components of the light module in this embodiment include a light emitting unit and a reflective cover, wherein the light emitting unit is preferably a light bar and the reflective cover includes a first reflective portion and a second reflective portion connected to each other (please refer to the embodiments shown in FIG. 1 and FIG. 2). The light guide plate includes a light incident side, a light emitting surface, and a bottom surface, wherein the light emitting surface and the bottom surface are two opposite surfaces formed on the edge of the light incident side, and the light emitting surface faces the optical film. As shown in FIG. 11, in addition to the step 110, step 120, and step 130 mentioned above, the step 141 includes disposing the light emitting unit to emit light toward the light incident side of the light guide plate and the step 142 includes disposing the reflective cover with the first reflective portion disposed along the light incident side of the light guide plate and the second reflective portion connected to the first reflective portion to extend from a plane where the first reflective portion is located toward the light guide plate and cross the boundary of the light incident side and the light emitting surface. The reflective cover reflects light from the light emitting unit to the light guide plate. In this embodiment, the light emitting surface of the light guide plate includes a light emitting portion and an edge potion, wherein the optical film is located on the light emitting portion. The step 142 preferably includes attaching the second reflective portion to the edge portion.

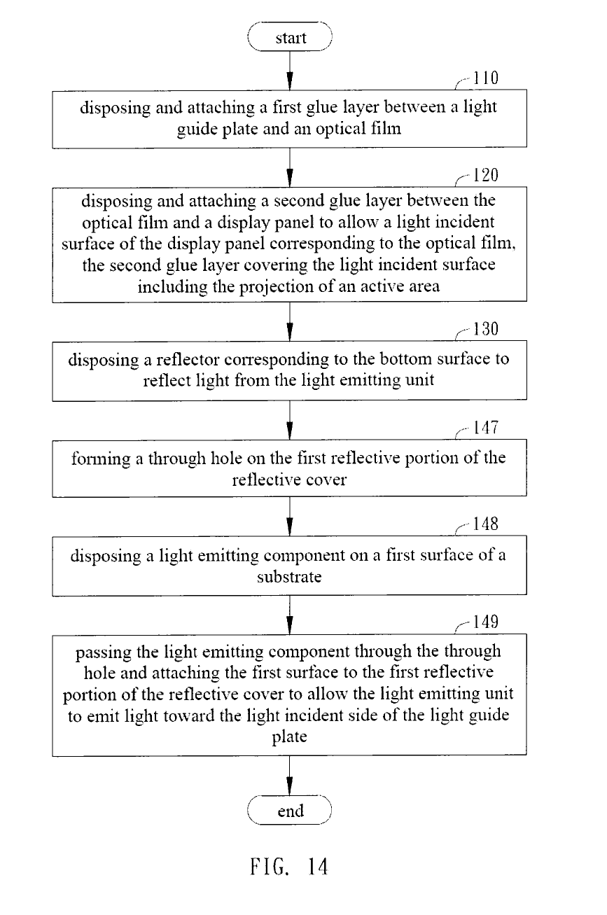

However, in other embodiments, the reflective cover with different design may be adopted. FIG. 12 is a schematic view of the processing steps of the third embodiment of the manufacturing method of the flat panel display structure. When the reflector includes a first reflective portion, a second reflective portion, and a third reflective portion (please refer to the FIG. 5), as shown in FIG. 12, in addition to the step 110, step 120, step 130, and the step 141 mentioned above, the step 143 includes disposing the reflective cover with the first reflective portion disposed along the light incident side of the light guide plate and the second reflective portion and the third reflective portion connected to two ends of the first reflective portion respectively to extend from a plane where the first reflective portion is located toward the light guide plate and cross the boundary of the light incident side and the light emitting surface, wherein the reflective cover reflects light from the light emitting unit to the light guide plate. In this embodiment, the step 143 preferably includes attaching the third reflective portion to the bottom surface.

FIG. 13 is a schematic view of the processing steps of the fourth embodiment of the manufacturing method of the flat panel display structure. Besides the related components mentioned in above embodiments, a back plate is further provided. The back plate has a bottom plate and a sidewall connected at an angle, wherein the sidewall includes an inner surface opposite to an outer surface and the first reflective portion of the reflective cover is disposed along the light incident side, and the second reflective portion extends from a plane where the first reflective portion is located toward the light guide plate and crosses the boundary of the light incident side and the light emitting surface (please refer to FIG. 4). As shown in FIG. 13, in addition to the step 110, step 120, and step 130 mentioned above, the step 144 includes disposing the light emitting unit on the inner surface of the sidewall of the back plate; step 145 includes disposing the light guide plate on the bottom plate of the back plate to allow the inner surface of the sidewall of the back plate to correspond to the light guide plate; step 146 includes disposing the reflective cover and attaching the first reflective portion of the reflective cover to the outer surface of the sidewall of the back plate. In a preferred embodiment, the light guide plate, the optical film, the display panel, and the reflector can be combined through step 110, step 120, and step 130, and the light emitting unit, the light guide plate, and the reflective cover can be disposed according to the step 144, step 145, and step 146 to simplify the assembling procedure and to facilitate mass production.

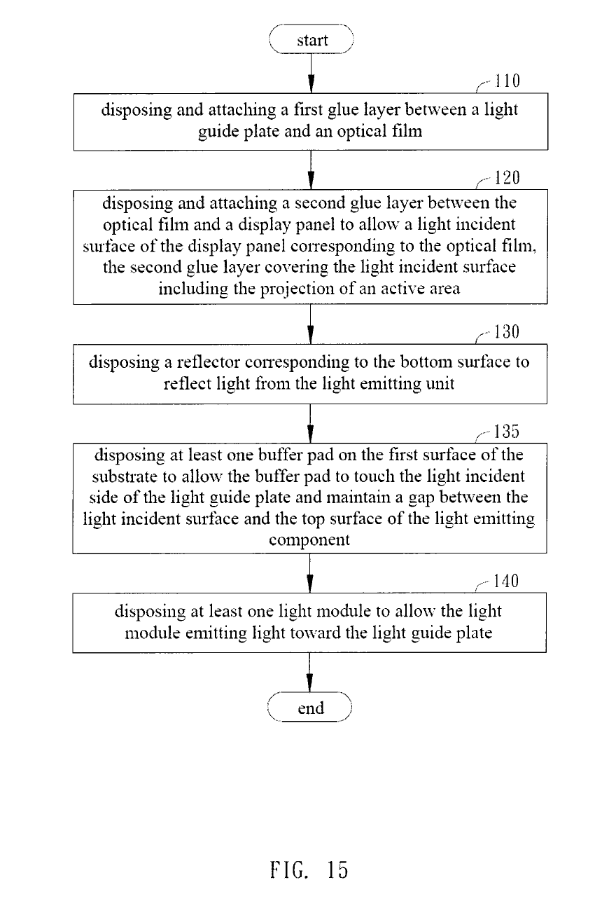

FIG. 14 is a schematic view of the processing steps of the fifth embodiment of the manufacturing method of the flat panel display structure. The related components of the light emitting unit in this embodiment include a substrate and a plurality of light emitting components, wherein the substrate has a first surface facing the light incident side of the light guide plate. The reflective cover includes a first reflective portion, a second reflective portion, and a third reflective portion connected to each other (please refer to FIG. 6A and FIG. 6B). As shown in FIG. 14, in addition to the step 110, step 120, and step 130 mentioned above, the step 147 includes forming a through hole on the first reflective portion of the reflective cover; the step 148 includes disposing the light emitting components on the first surface of the substrate; the step 149 includes passing the light emitting component through the through hole and attaching the first surface to the first reflective portion of the reflective cover to allow the light emitting unit to emit light toward the light incident side of the light guide plate.

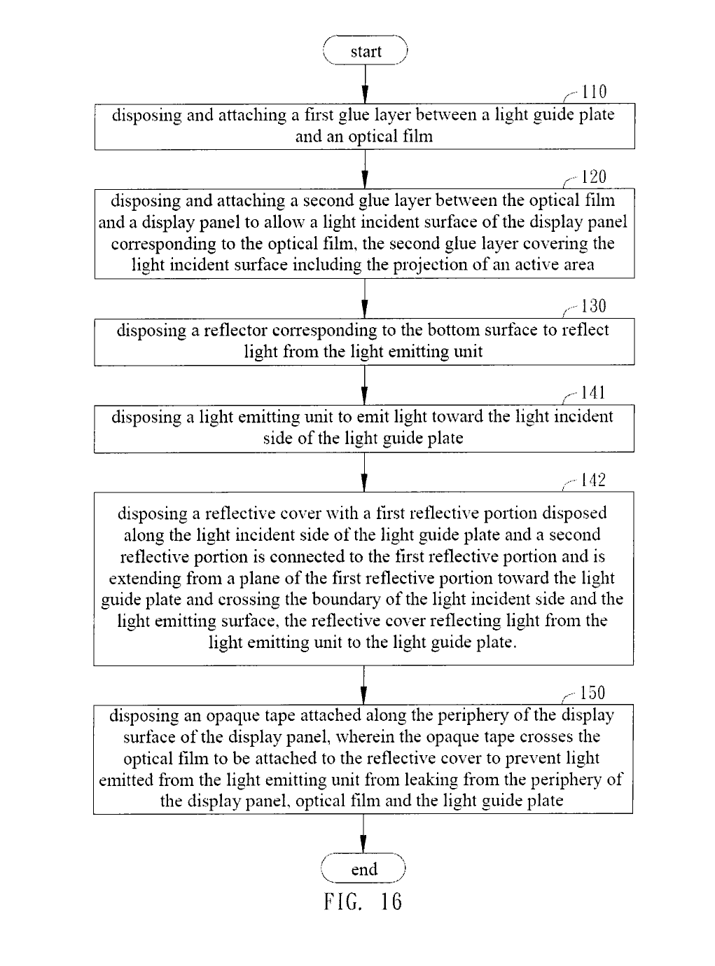

For the convenient positioning as assembling the light emitting unit and to prevent the light emitting component from directly contacting the light guide plate and causing damage, a buffer pad may be disposed between the light emitting unit and the light guide plate. FIG. 15 is a schematic view of the processing steps of the sixth embodiment of the manufacturing method of the flat panel display structure. In addition to the components shown in FIG. 10, the buffer pad is included. Moreover, the light module includes a light emitting unit having a substrate and a light emitting component wherein the substrate has a first surface facing the light incident side of the light guide plate. The light emitting component has a top surface facing the light incident side (please refer to the FIG. 7A and the FIG. 7B). As shown in FIG. 15, in addition to the step 110, step 120, step 130, and step 140 mentioned above, the step 135 includes disposing at least one buffer pad on the first surface of the substrate to allow the buffer pad to touch the light incident side of the light guide plate and maintain a gap between the light incident surface and the top surface of the light emitting component.

FIG. 16 is a schematic view of the processing steps of the seventh embodiment of the manufacturing method of the flat panel display structure. In addition to components shown in FIG. 11, a black light-shielding tape (please refer to the FIG. 8A and the FIG. 8B) is included. As shown in FIG. 16. in addition to the step 110, step 120, step 130, step 141 and step 142 mentioned above, the step 150 includes disposing and attaching the black light-shielding tape along the periphery of the display surface of the display panel, wherein the black light-shielding tape crosses the optical film to be attached to the reflective cover to prevent light emitted from the light emitting unit from leaking from the periphery of the display panel, the optical film and the light guide plate. In a preferred embodiment, the black light-shielding tape is Mylar tape; however, in other embodiments, other types of tapes may be adopted. In this embodiment having the black light-shielding tape, the reflector is preferably attached to the bottom surface of the light guide plate to reflect light from the light emitting unit toward the light guide plate. Meanwhile, the flat panel display structure may be assembled with an outer frame to form a complete flat display product. Furthermore, the embodiments shown in FIG. 12, FIG. 13, and FIG. 14 may include the step of the disposing the black light-shielding tape to form different flat display structures as required (please refer to FIG. 9A, FIG. 9B, and FIG. 9C).

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A flat panel display structure, comprising:
a light guide plate made of optical glass;
at least an optical film disposed on the light guide plate;
a first glue layer attaching the light guide plate to the optical film, wherein the refractive index of the first glue layer is equal to or smaller than the refractive index of the light guide plate and the refractive index of the optical film;
a display panel with a light incident surface and a display surface opposite to the light incident surface, wherein the light incident surface faces the optical film, and an active area is located on a central portion of the display surface;
a second glue layer attaching the optical film to the display panel, the second glue layer covering the light incident surface including the projection of the active area thereon, wherein the refractive index of the second glue layer is equal to or smaller than the refractive index of the light guide plate and the refractive index of the optical film; and
at least one light module emitting light toward the light guide plate.

2. The flat panel display structure of claim 1, wherein a light shielding layer is disposed on a periphery of a surface of the optical film facing the display panel or of another surface of the optical film opposite to the display panel, the light shielding layer extends inward to cross the projection of the display panel on the optical film, the second glue layer at least partially covers the light shielding layer.

3. The flat panel display structure of claim 1, wherein the light guide plate comprises a light incident side and a light emitting surface, the light emitting surface is connected to a side edge of the light incident side and corresponds to the optical film, the light module comprises a light emitting unit and a reflective cover, wherein the light emitting unit emits light toward the light incident side, the reflective cover reflects light from the light emitting unit to the light guide plate and comprises a first reflective portion and a second reflective portion connected to each other, wherein the first reflective portion is disposed along the light incident side, the second reflective portion extends from a plane where the first reflective portion is located toward the light guide plate and crosses the boundary of the light incident side and the light emitting surface.

4. The flat panel display structure of claim 3, further comprising a back plate with a bottom plate and a sidewall connected to each other, the light guide plate is disposed on the bottom plate, the sidewall has an inner surface and an outer surface, wherein the inner surface faces the light guide plate, the light emitting unit is disposed on the inner surface, the first reflective portion of the reflective cover is attached to the outer surface.

5. The flat panel display structure of claim 3, wherein the light emitting surface comprises a light emitting portion and an edge portion adjacent to each other, the optical film is disposed on the light emitting portion, and the second reflective portion of the light module is attached to the edge portion.

6. The flat panel display structure of claim 3, wherein the light guide plate further comprises a bottom surface opposite to the light emitting surface, the bottom surface is connected to the side edge of the light incident side, the reflective cover further comprises a third reflective portion connected to the first reflective portion, wherein the third reflective portion extends from a plane where the first reflective portion is located toward the light guide plate and crosses the boundary of the light incident side and the bottom surface.

7. The flat panel display structure of claim 6, wherein the third reflective portion is attached to the bottom surface.

8. The planar display structure of claim 6, further comprising a reflector disposed corresponding to the bottom surface, wherein the reflector reflects light from the emitting unit to the light guide plate, and the third reflective portion is attached to the reflector.

9. The flat panel display structure of claim 6, wherein the light emitting unit comprises a substrate and at least one light emitting component, the substrate comprises a first surface corresponding to the light incident side of the light guide plate, the light emitting component is disposed on the first surface and emits light toward the light incident side.

10. The flat panel display structure of claim 9, wherein a through hole is formed on the first reflective portion of the reflective cover to allow the light emitting component to pass therethrough, the first surface of the substrate is attached to the first reflective portion.

11. The planar display structure of claim 9, wherein the substrate further comprises a second surface opposite to the first surface, the second surface is attached to the first reflective portion.

12. The flat panel display structure of claim 6, further comprising a black light-shielding tape attached along the periphery of the display surface of the display panel, wherein the black light-shielding tape crosses the optical film to be attached to the reflective cover to prevent light emitted from the light emitting unit from leaking from the periphery of the display panel, the optical film, and the light guide plate.

13. The flat panel display structure of claim 12, wherein the black light-shielding tape is Mylar tape.

14. The flat panel display structure of claim 12, further comprising a reflector attached to the bottom surface of the light guide plate to reflect light from the light emitting unit to the light guide plate.

15. The flat panel display structure of claim 1, further comprising a reflector, wherein the light guide plate comprises a bottom surface opposite to the optical film, the reflector is disposed corresponding to the bottom surface and reflects light from the light emitting unit to the light guide plate.

16. The flat panel display structure of claim 1, wherein the refractive indices of the first glue layer and the second glue layer are substantially between 1.2 and 1.4.

17. The flat panel display structure of claim 1, wherein the optical film is a multilayer composite film.

18. The flat panel display structure of claim 1, wherein the light module comprises a light emitting unit including a substrate and at least one light emitting component, the substrate comprises a first surface corresponding to the light incident side of the light guide plate, the flat panel display structure further comprises at least one buffer pad disposed on the first surface, the light emitting component has a top surface opposite to the light incident side of the light guide plate, the buffer pad touches the light incident side to maintain a gap between the top surface and the light incident side.

19. A manufacturing method of a flat panel display structure, comprising:
disposing and attaching a first glue layer between a light guide plate and an optical film, wherein the light guide plate is made of optical glass and the refractive index of the first glue layer is equal to or smaller than the refractive indices of the light guide plate and the optical film;
disposing and attaching a second glue layer between the optical film and a display panel to allow a light incident surface of the display panel corresponding to the optical film, the second glue layer covering the light incident surface including the projection of an active area, wherein the display panel comprises a display surface opposite to the light incident surface, the active area is located on a central portion the display surface, the refractive index of the second glue layer is equal to or smaller than the refractive indices of the light guide plate and the optical film; and
disposing at least one light module to allow the light module to emit light toward the light guide plate.

20. The manufacturing method of claim 19, wherein the step of disposing the first glue layer further comprises forming a light shielding layer on a periphery of a surface of the optical film facing the display panel or of another surface of the optical film opposite to the display panel, the light shielding layer extends inward to cross the projection of the display panel on the optical film, the step of disposing the second glue layer further comprises at least partially covering the light shield layer with the second glue layer.

21. The manufacturing method of claim 19, wherein the light guide plate comprises a light incident side and a light emitting surface, the light emitting surface is connected to a side edge of the light incident side and corresponds to the optical film, the step of disposing the light module comprises:
disposing a light emitting unit to emit light toward the light incident side of the light guide plate; and
disposing a reflective cover with a first reflective portion disposed along the light incident side of the light guide plate and a second reflective portion extending from a plane where the first reflective portion is located toward the light guide plate and crossing the boundary of the light incident side and the light emitting surface, the reflective cover reflecting light from the light emitting unit to the light guide plate.

22. The manufacturing method of claim 21, wherein the step of disposing the light emitting unit comprises:
disposing the light emitting unit on an inner surface of a sidewall of a back plate, wherein the sidewall has an outer surface opposite to the inner surface; and
disposing the light guide plate on a bottom plate of the back plate to allow the inner surface of the sidewall of the back plate to correspond to the light guide plate, wherein the bottom plate is connected to the sidewall;
wherein the step of disposing the reflective cover further comprises attaching the first reflective portion of the reflective cover to the outer surface of the sidewall of the back plate.

23. The manufacturing method of claim 21, wherein the light emitting surface comprises a light emitting portion and an edge portion adjacent to each other, the optical film is located on the light emitting portion, the step of disposing the reflective cover further comprises attaching the second reflective portion of the reflective cover to the edge portion.

24. The manufacturing method of claim 21, wherein the light guide plate further comprises a bottom surface connected to the side edge of the light incident side to be opposite to the light emitting surface, the step of disposing the reflective cover further comprises allowing a third reflective portion of the reflective cover to extend from a plane where the first reflective portion is located toward the light guide plate and cross the boundary of the light incident side and the bottom surface.

25. The manufacturing method of claim 24, wherein the step of disposing the reflective cover further comprises attaching the third reflective portion to the bottom surface.

26. The manufacturing method of claim 24, further comprising disposing a reflector corresponding to the bottom surface to reflect light from the light emitting unit, wherein the step of disposing the reflective cover further comprises attaching the third reflective portion to the reflector.

27. The manufacturing method of claim 24, wherein the step of disposing the light emitting unit comprises disposing at least one light emitting component on a first surface of a substrate to allow the light emitting component to emit light toward the light guide plate, wherein the first surface corresponds to the light incident side of the light guide plate.

28. The manufacturing method of claim 27, wherein the step of disposing the reflective cover further comprises:
forming a through hole on the first reflective portion of the reflective cover;
wherein the step of disposing the reflective cover further comprises:
passing the light emitting component through the through hole; and
attaching the first surface of the substrate to the first reflective portion of the reflective cover.

29. The manufacturing method of claim 27, wherein the substrate further comprises a second surface opposite to the first surface, the step of disposing the reflective cover further comprises attaching the second surface of the substrate to the first reflective portion of the reflective cover.

30. The manufacturing method of claim 24, further comprising disposing a black light-shielding tape attached along the periphery of the display surface of the display panel, wherein the black light-shielding tape crosses the optical film to be attached to the reflective cover to prevent light emitted from the light emitting unit from leaking from the periphery of the display panel, the optical film and the light guide plate.

31. The manufacturing method of claim 30, further comprising disposing a reflector attached to the bottom surface of the light guide plate to reflect light from the light emitting unit toward the light guide plate.

32. The manufacturing method of claim 19, wherein the light guide plate comprises a bottom surface opposite to the optical film, the manufacturing method further comprises disposing a reflector corresponding to the bottom surface to reflect light from the light emitting unit toward the light guide plate.

33. The manufacturing method of claim 19, wherein the light module comprises a light emitting unit with a substrate and at least one light emitting component, the substrate comprises a first surface corresponding to the light incident side of the light guide plate, the light emitting component has a top surface corresponding to the light incident side of the light guide plate, wherein the step of disposing the light emitting unit further comprises disposing at least one buffer pad on the first surface of the substrate to allow the buffer pad to touch the light incident side of the light guide plate and maintain a gap between the light incident surface and the top surface of the light emitting component.
